(19) United States
(12) Patent Application Publication
(10) Pub. No.: US 2026/0145101 A1
(43) Pub. Date: May 28, 2026

(54) BASKET STRAINERS FOR OIL RECOVERY SYSTEMS

(71) Applicant: Double Drop Services LLC, Choctaw, OK (US)

(72) Inventors: Jerry David Mick, Odessa, TX (US); Christopher Harvey Price, Choctaw, OK (US)

(21) Appl. No.: 19/396,894

(22) Filed: Nov. 21, 2025

Related U.S. Application Data
(60) Provisional application No. 63/723,969, filed on Nov. 22, 2024.

(51) Int. Cl. B01D 29/35; E21B 43/38

(52) U.S. Cl. CPC B01D 29/35; E21B 43/38; B01D 2201/302

(57) ABSTRACT

A basket strainer for an oil recovery system includes a pot constructed of high-density polyethylene. The pot includes an inlet port having an inlet opening and an inlet passageway in fluid communication with the inlet opening. A strainer housing includes a housing chamber in fluid communication with the inlet passageway. An outlet port includes an outlet passageway in fluid communication with the housing chamber and an outlet opening in fluid communication with the outlet passageway. A strainer is positioned in the housing chamber and is configured to remove particulate matter from a fluid flowing from the inlet opening through the inlet passageway, the housing chamber, the outlet passageway, and out of the outlet opening.

### CROSS-REFERENCE TO RELATED APPLICATION

The present application claims the benefit of and priority to U.S. Provisional Application Ser. No. 63/723,969, filed Nov. 22, 2024, which is hereby incorporated by reference in its entirety for all purposes.

### FIELD OF THE DISCLOSURE

The present disclosure generally relates to basket strainers for removing particulate matter from water and oil flowing through oil recovery systems.

### BACKGROUND

Oil recovery systems typically include one or more basket strainers for removing particulate matter from water and oil flows that tends to rapidly corrode systems components. However, typical basket strainers have one or more disadvantages. For example, typical basket strainers are filled and clog frequently, requiring servicing and leading to system downtime. In some cases basket strainers include filters or strainers with relatively large apertures (for example, ⅜ inch) to reduce clogging frequency, although this undermines the objective of removing particulate matter from the fluid. As another example, the main bodies or “pots” of typical basket strainers are constructed from expensive and/or materials that tend to corrode, such as carbon steel, nickel-plated steel, or stainless steel (SS). Accordingly, improved basket strainers would be beneficial.

### SUMMARY

In one exemplary embodiment (“Example 1”), a basket strainer for an oil recovery system includes: a pot constructed of high-density polyethylene, the pot including: an inlet port including an inlet opening and an inlet passageway in fluid communication with the inlet opening; a strainer housing including a housing chamber in fluid communication with the inlet passageway; an outlet port including an outlet passageway in fluid communication with the housing chamber and an outlet opening in fluid communication with the outlet passageway; and a strainer positioned in the housing chamber and configured to remove particulate matter from a fluid flowing from the inlet opening through the inlet passageway, the housing chamber, the outlet passageway, and out of the outlet opening.

In another exemplary embodiment (“Example 2”), the basket strainer of Example 1, wherein the inlet port further includes an inlet nipple, and the basket strainer further includes an inlet pressure transducer coupled to the inlet nipple.

In another exemplary embodiment (“Example 3”), the basket strainer of Example 2, wherein the outlet port further includes an outlet nipple, and the basket strainer further includes an outlet pressure transducer coupled to the outlet nipple.

In another exemplary embodiment (“Example 4”), the basket strainer of Example 1, wherein the outlet port further includes an outlet nipple, and the basket strainer further includes an outlet pressure transducer coupled to the outlet nipple.

In another exemplary embodiment (“Example 5”), the basket strainer of Example 1, wherein the strainer includes a strainer wall and a plurality of apertures defined in the strainer wall, each of the plurality of apertures having a diameter of about ⅛ inch.

In another exemplary embodiment (“Example 6”), the basket strainer of Example 1, wherein the strainer includes a strainer wall and a plurality of apertures defined in the strainer wall, each of the plurality of apertures having a diameter of about ¼ inch.

In another exemplary embodiment (“Example 7”), the basket strainer of Example 1, wherein the strainer includes a strainer wall and a plurality of apertures defined in the strainer wall, the strainer wall being constructed of stainless steel.

In another exemplary embodiment (“Example 8”), the basket strainer of Example 1, wherein the strainer housing has an outer diameter of about 16 inches.

In another exemplary embodiment (“Example 9”), the basket strainer of Example 1, wherein the inlet port has an outer diameter of about 8 inches.

In another exemplary embodiment (“Example 10”), the basket strainer of Example 1, wherein the outlet port has an outer diameter of about 8 inches.

In another exemplary embodiment (“Example 11”), the basket strainer of Example 1, wherein the strainer housing has a wall thickness according to SDR 7.

In another exemplary embodiment (“Example 12”), the basket strainer of Example 1, wherein the inlet port has a wall thickness according to SDR 7.

In another exemplary embodiment (“Example 13”), the basket strainer of Example 1, wherein the outlet port has a wall thickness according to SDR 7.

In another exemplary embodiment (“Example 14”), the basket strainer of Example 1, further including a strainer support positioned in the housing chamber, the strainer support supporting the strainer.

In another exemplary embodiment (“Example 15”), the basket strainer of Example 14, wherein the housing chamber is partially defined by a lower surface, and the strainer support is positioned on the lower surface.

In another exemplary embodiment (“Example 16”), the basket strainer of Example 1, further including an access port defining an access opening and an access passageway in fluid communication with the access opening and the housing chamber, the strainer being removable from the housing chamber via the access passageway and the access opening.

In another exemplary embodiment (“Example 17”), the basket strainer of Example 16, further including: an access cover; and an access mounting ring movably positioned on the access port, the access mounting ring selectively coupling the access cover to the access port.

In another exemplary embodiment (“Example 18”), the basket strainer of Example 17, further including a mounting ring stop coupled to the access port, the mounting ring stop limiting movement of the access mounting ring relative to the access port.

In another exemplary embodiment (“Example 19”), the basket strainer of Example 1, further including an inlet mounting ring movably positioned on the inlet port, the inlet mounting ring configured to couple the inlet port to an upstream conduit.

In another exemplary embodiment (“Example 20”), the basket strainer of Example 1, further including an outlet mounting ring movably positioned on the outlet port, the outlet mounting ring configured to couple the outlet port to a downstream conduit.

In another exemplary embodiment (“Example 21”), an oil recovery system including: a first basket strainer including: a first pot including: a first inlet port including a first inlet opening and a first inlet passageway in fluid communication with the first inlet opening; a first strainer housing including a first housing chamber in fluid communication with the first inlet passageway; a first outlet port including a first outlet passageway in fluid communication with the first housing chamber and a first outlet opening in fluid communication with the first outlet passageway; a first strainer positioned in the first housing chamber, the first strainer including a first strainer wall and a plurality of first apertures defined in the first strainer wall, each of the plurality of first apertures having a first diameter, and the first strainer configured to remove particulate matter from water flowing from the first inlet opening through the first inlet passageway, the first housing chamber, the first outlet passageway, and out of the first outlet opening; intermediate recovery equipment in downstream fluid communication with the first basket strainer and receiving water from the first basket strainer; a second basket strainer in downstream fluid communication with the intermediate recovery equipment and receiving crude oil from the intermediate recovery equipment, the second basket strainer including: a second pot including: a second inlet port including a second inlet opening and a second inlet passageway in fluid communication with the second inlet opening; a second strainer housing including a second housing chamber in fluid communication with the second inlet passageway; a second outlet port including a second outlet passageway in fluid communication with the second housing chamber and a second outlet opening in fluid communication with the second outlet passageway; and a second strainer positioned in the second housing chamber, the second strainer including a second strainer wall and a plurality of second apertures defined in the second strainer wall, each of the plurality of second apertures having a second diameter, the second diameter being greater than the first diameter, and the second strainer configured to remove particulate matter from crude oil flowing from the second inlet opening through the second inlet passageway, the second housing chamber, the second outlet passageway, and out of the second outlet opening.

In another exemplary embodiment (“Example 22”), the oil recovery system of Example 21, wherein the first diameter is about ⅛ inch.

In another exemplary embodiment (“Example 23”), the oil recovery system of Example 22, wherein the second diameter is about ¼ inch.

In another exemplary embodiment (“Example 24”), the oil recovery system of Example 21, wherein the second diameter is about ¼ inch.

In another exemplary embodiment (“Example 25”), the oil recovery system of Example 21, wherein the first basket strainer is constructed of high-density polyethylene.

In another exemplary embodiment (“Example 26”), the oil recovery system of Example 21, wherein the second basket strainer is constructed of high-density polyethylene.

In another exemplary embodiment (“Example 27”), the oil recovery system of Example 21, wherein the oil recovery system lacks any bleeder rings coupled to the first basket strainer and the second basket strainer.

In another exemplary embodiment (“Example 28”), the oil recovery system of Example 21, wherein the first inlet port further includes a first inlet nipple, and wherein the first basket strainer further includes a first inlet pressure transducer coupled to the first inlet nipple.

In another exemplary embodiment (“Example 29”), the oil recovery system of Example 21, wherein the second inlet port further includes a second inlet nipple, and wherein the second basket strainer further includes a second inlet pressure transducer coupled to the second inlet nipple.

In another exemplary embodiment (“Example 30”), the oil recovery system of Example 21, wherein the first outlet port further includes a first outlet nipple, and the first basket strainer further includes a first outlet pressure transducer coupled to the first outlet nipple.

In another exemplary embodiment (“Example 31”), the oil recovery system of Example 21, wherein the second outlet port further includes a second outlet nipple, and the second basket strainer further includes a second outlet pressure transducer coupled to the second outlet nipple.

In another exemplary embodiment (“Example 32”), the oil recovery system of Example 21, wherein the first strainer wall is constructed of stainless steel.

In another exemplary embodiment (“Example 33”), the oil recovery system of Example 21, wherein the second strainer wall is constructed of stainless steel.

In another exemplary embodiment (“Example 34”), the oil recovery system of Example 21, wherein the first strainer housing has an outer diameter of about 16 inches.

In another exemplary embodiment (“Example 35”), the oil recovery system of Example 21, wherein the second strainer housing has an outer diameter of about 16 inches.

In another exemplary embodiment (“Example 36”), the oil recovery system of Example 21, wherein the first inlet port has an outer diameter of about 8 inches.

In another exemplary embodiment (“Example 37”), the oil recovery system of Example 21, wherein the second inlet port has an outer diameter of about 8 inches.

In another exemplary embodiment (“Example 38”), the oil recovery system of Example 21, wherein the first outlet port has an outer diameter of about 8 inches.

In another exemplary embodiment (“Example 39”), the oil recovery system of Example 21, wherein the second outlet port has an outer diameter of about 8 inches.

In another exemplary embodiment (“Example 40”), the oil recovery system of Example 21, wherein the first strainer housing has a wall thickness according to SDR7.

In another exemplary embodiment (“Example 41”), the oil recovery system of Example 21, wherein the second strainer housing has a wall thickness according to SDR7.

In another exemplary embodiment (“Example 42”), the oil recovery system of Example 21, wherein the first inlet port has a wall thickness according to SDR7.

In another exemplary embodiment (“Example 43”), the oil recovery system of Example 21, wherein the second inlet port has a wall thickness according to SDR7.

In another exemplary embodiment (“Example 44”), the oil recovery system of Example 21, wherein the first outlet port has a wall thickness according to SDR7.

In another exemplary embodiment (“Example 45”), the oil recovery system of Example 21, wherein the second outlet port has a wall thickness according to SDR7.

In another exemplary embodiment (“Example 46”), the oil recovery system of Example 21, further including a first strainer support positioned in the first housing chamber, the first strainer support supporting the first strainer.

In another exemplary embodiment (“Example 47”), the oil recovery system of Example 46, wherein the first housing chamber is partially defined by a first lower surface, and the first strainer support is positioned on the first lower surface.

In another exemplary embodiment (“Example 48”), the oil recovery system of Example 21, further including a second strainer support positioned in the second housing chamber, the second strainer support supporting the second strainer.

In another exemplary embodiment (“Example 49”), the oil recovery system of Example 48, wherein the second housing chamber is partially defined by a second lower surface, and the second strainer support is positioned on the second lower surface.

In another exemplary embodiment (“Example 50”), the oil recovery system of Example 21, wherein the first basket strainer further includes a first access port defining a first access opening and a first access passageway in fluid communication with the first access opening and the first housing chamber, the first strainer being removable from the first housing chamber via the first access passageway and the first access opening.

In another exemplary embodiment (“Example 51”), the oil recovery system of Example 50, wherein the first basket strainer further includes: a first access cover; and a first access mounting ring movably positioned on the first access port, the first access mounting ring selectively coupling the first access cover to the first access port.

In another exemplary embodiment (“Example 52”), the oil recovery system of Example 51, wherein the first basket strainer further includes a first mounting ring stop coupled to the first access port, the first mounting ring stop limiting movement of the first access mounting ring relative to the first access port.

In another exemplary embodiment (“Example 53”), the oil recovery system of Example 21, wherein the second basket strainer further includes a second access port defining a second access opening and a second access passageway in fluid communication with the second access opening and the second housing chamber, the second strainer being removable from the second housing chamber via the second access passageway and the second access opening.

In another exemplary embodiment (“Example 54”), the oil recovery system of Example 53, wherein the second basket strainer further includes: a second access cover; and a second access mounting ring movably positioned on the second access port, the second access mounting ring selectively coupling the second access cover to the second access port.

In another exemplary embodiment (“Example 55”), the oil recovery system of Example 54, wherein the second basket strainer further includes a second mounting ring stop coupled to the second access port, the second mounting ring stop limiting movement of the second access mounting ring relative to the second access port.

In another exemplary embodiment (“Example 56”), the oil recovery system of Example 21, wherein the first basket strainer further includes a first inlet mounting ring movably positioned on the first inlet port, the first inlet mounting ring configured to couple the first inlet port to an upstream conduit.

In another exemplary embodiment (“Example 57”), the oil recovery system of Example 21, wherein the second basket strainer further includes a second inlet mounting ring movably positioned on the second inlet port, the second inlet mounting ring coupling the second inlet port to the intermediate recovery equipment.

In another exemplary embodiment (“Example 58”), the oil recovery system of Example 21, wherein the first basket strainer further includes a first outlet mounting ring movably positioned on the first outlet port, the first outlet mounting ring coupling the first outlet port to the intermediate recovery equipment.

In another exemplary embodiment (“Example 59”), the oil recovery system of Example 21, wherein the second basket strainer further includes a second outlet mounting ring movably positioned on the second outlet port, the second outlet mounting ring configured to couple the second outlet port to a downstream conduit.

In another exemplary embodiment (“Example 60”), a strainer for a basket strainer, including: a strainer wall; and a plurality of apertures formed in the strainer wall, each of the plurality of apertures having a diameter of about ¼ inch to about ⅛ inch.

In another exemplary embodiment (“Example 61”), the strainer of Example 60, wherein the strainer wall is constructed of stainless steel.

In another exemplary embodiment (“Example 62”), the strainer of Example 60, further including a rim coupled to the strainer wall.

In another exemplary embodiment (“Example 63”), the strainer of Example 62, further including a base coupled to the strainer wall opposite the rim.

In another exemplary embodiment (“Example 64”), the strainer of Example 63, wherein the rim extends diagonally relative to the base.

In another exemplary embodiment (“Example 65”), the strainer of Example 62, further including a handle coupled to the rim.

In another exemplary embodiment (“Example 66”), an oil recovery system including: an upstream conduit configured to provide a fluid; a basket strainer including: a pot including: an inlet port including an inlet opening configured to receive the fluid from the upstream conduit, and an inlet passageway in fluid communication with the inlet opening; a strainer housing including a housing chamber in fluid communication with the inlet passageway; an outlet port including an outlet passageway in fluid communication with the housing chamber and an outlet opening in fluid communication with the outlet passageway; a strainer positioned in the housing chamber, the strainer including a strainer wall and a plurality of apertures defined in the strainer wall, the strainer configured to remove particulate matter from the fluid flowing from the inlet opening through the inlet passageway, the housing chamber, the outlet passageway, and out of the outlet opening; a downstream conduit configured to receive the fluid from the outlet opening of the basket strainer; a bypass conduit in fluid communication with the upstream conduit and the downstream conduit; and a valve configured to direct the fluid away from the basket strainer.

In another exemplary embodiment (“Example 67”), the strainer of Example 66, wherein the valve is an upstream valve positioned along the upstream conduit.

In another exemplary embodiment (“Example 68”), the strainer of Example 66, wherein the valve is a downstream valve positioned along the downstream conduit.

In another exemplary embodiment (“Example 69”), the strainer of Example 66, wherein the valve is a bypass valve positioned along the bypass conduit.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 illustrates a side view of a basket strainer, according to an embodiment of the present disclosure.

FIG. 2 illustrates a side perspective view of a strainer of the basket strainer of FIG. 1, according to an embodiment of the present disclosure.

FIG. 3 illustrates a side view of an oil recovery system including a first, or water side, basket strainer and a second, or oil side, basket strainer, according to an embodiment of the present disclosure.

FIG. 4 illustrates a side view of a basket strainer, according to another embodiment of the present disclosure.

FIG. 5 illustrates a side view of an oil recovery system including a basket strainer and a bypass conduit, according to an embodiment of the present disclosure.

It should be understood that the drawings are intended facilitate understanding of exemplary embodiments of the present invention are not necessarily to scale.

### DETAILED DESCRIPTION

The following description refers to the accompanying drawings which show specific embodiments. Although specific embodiments are shown and described, it is to be understood that additional and/or alternative features are employed in other embodiments. The following detailed description is not to be taken in a limiting sense, and the scope of the claimed invention is defined by the appended claims and their equivalents.

It should be understood that like reference numerals are intended to identify the same structural components, elements, portions, or surfaces consistently throughout the several drawing figures, as such components, elements, portions, or surfaces may be further described or explained by the entire written specification, of which this detailed description is an integral part. Unless otherwise indicated, the drawings are intended to be read (for example, cross-hatching, arrangement of parts, proportion, degree, etc.) together with the specification, and are to be considered a portion of the written description.

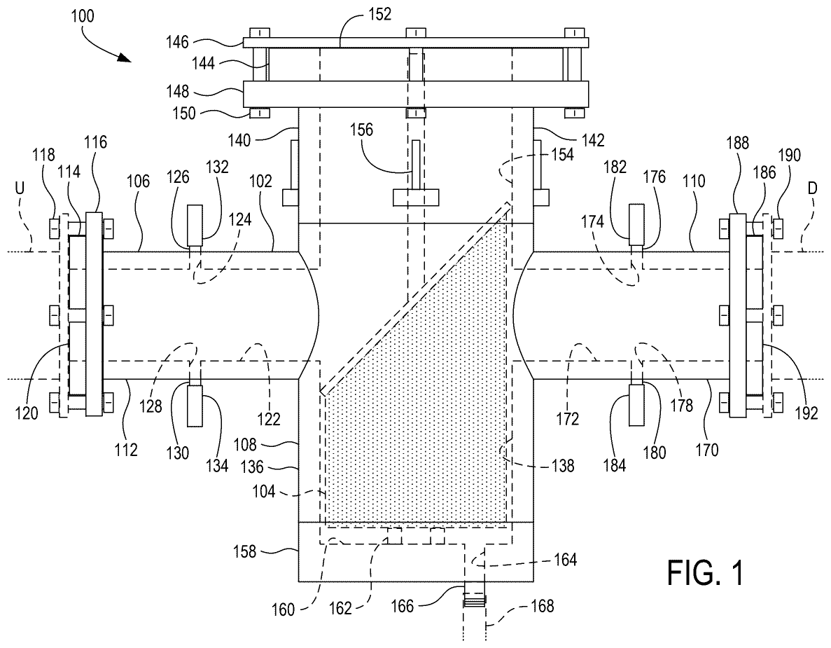

FIG. 1 illustrates a basket strainer 100 for an oil recovery system, according to an embodiment of the present disclosure. Generally, the basket strainer 100 includes a main body 102, also referred to as a pot, through which a fluid (for example, water or oil, more specifically salt water or crude oil, respectively) passes during oil recovery. Particulate material is removed from the fluid by a strainer 104 positioned within the pot 102. As described in further detail below, the basket strainer 100 requires service less frequently than previous basket strainers, thereby decreasing downtime of the oil recovery system.

The pot 102 is constructed of one or more relatively inexpensive corrosion-resistant materials, such as polymers, more specifically polyethylene, and even more specifically high-density polyethylene (HDPE). In other embodiments, the pot 102 is constructed of one or more different materials. The pot 102 also has a relatively large size compared to those of previous basket strainers. Illustratively, the pot 102 has an overall height (that is, in the vertical direction as shown in FIG. 1) of about 36 inches (as used herein, the term “about” understood as the stated value +/−5 percent) and an overall width (that is, in the horizontal direction as shown in FIG. 1) of about 47 inches.

With continued reference to FIG. 1, the pot 102 generally includes an inlet port 106, a strainer housing 108, and an outlet port 110 through which the fluid flows during oil recovery. The inlet port 106 includes an inlet wall 112 that defines an inlet flange 114, and the inlet flange 114 abuts an upstream conduit U. The inlet flange 114 may be provided with various sizes, depending on the size of the upstream conduit U. The inlet flange 114 couples to the upstream conduit U via an inlet mounting ring 116 that is movably mounted over the inlet wall 112 and a plurality of inlet fasteners 118 received by the inlet mounting ring 116. The inlet wall 112 defines at inlet opening 120 within the inlet flange 114, and the inlet opening 120 receives fluid from the upstream conduit U. The inlet opening 120 is also in fluid communication with an inlet passageway 122.

The inlet passageway 122 is illustratively in fluid communication with one or more auxiliary passageways, more specifically an upper inlet nipple passageway 124 of an upper inlet nipple 126 and a lower inlet nipple passageway 128 of a lower inlet nipple 130. The upper inlet nipple 126 and the lower inlet nipple 130 couple to pressure transducers, more specifically, an upper inlet pressure transducer 132 and a lower inlet pressure transducer 134, respectively. The pressure transducers, together with pressure transducers coupled to the outlet port 110 (described below), facilitate determining a pressure differential across the strainer 104 and thereby determining if the basket strainer 100 is excessively filled with particulate matter and requires servicing.

With further reference to FIG. 1, the inlet port 106 has an outer diameter, apart from the inlet flange 114, of about 8 inches. In other embodiments, the inlet port 106 has a different outer diameter. The inlet wall 112 of the inlet port 106 has a thickness according to SDR7 (that is, its standard dimension ratio, or the ratio of the outer diameter to the minimum wall thickness, is 7). Such a wall thickness facilitates potentially operating at high fluid pressures. In other embodiments, the inlet port 106 has a different wall thickness, such as SDR11.

With continued reference to FIG. 1, the strainer housing 108 includes a housing wall 136 that defines a housing chamber 138 in fluid communication with the inlet passageway 122. The housing chamber 138 receives the strainer 104. The strainer housing 108 has an outer diameter of about 16 inches. In other embodiments, the strainer housing 108 has a different outer diameter. The housing wall 136 of the strainer housing 108 has a thickness according to SDR7. In other embodiments, the strainer housing 108 has a different wall thickness, such as SDR11.

On its upper end, the strainer housing 108 is coupled to an access port 140. The access port 140 includes an access wall 142 that defines an access flange 144, and the access flange 144 abuts an access cover 146. The access port 140 couples to the access cover 146 via an access mounting ring 148 that is movably mounted over the access wall 142 and a plurality of access fasteners 150 received by the access mounting ring 148. The access wall 142 defines an access opening 152 within the access flange 144, and the access opening 152 is in fluid communication with an access passageway 154. The access passageway 154 is in fluid communication with the housing chamber 138. As a result, the strainer 104 is removable from the housing chamber 138 via the access passageway 154 and the access opening 152 when the access cover 146 is detached from the access port 140. The access port 140 also includes one or more mounting ring stops 156 (for example, four mounting ring stops 156, three being illustrated in FIG. 1) that limit movement of the access mounting ring 148 along the access port 140 when the access mounting ring 148 is detached from the access cover 146. As a result, the mounting ring stops 156 facilitating lifting and coupling the access mounting ring 148 to the access cover 146 with a single technician.

The access port 140 has an outer diameter, apart from the access flange 144, of about 16 inches. In other embodiments, the access port 140 has a different outer diameter. The access wall 142 of the access port 140 has a thickness according to SDR7. In other embodiments, the access port 140 has a different wall thickness, such as SDR11.

On its lower end, the strainer housing 108 is coupled to a housing base 158. The housing base 158 includes a lower surface 160 that partially defines the housing chamber 138, and one or more strainer supports 162 (for example, two strainer supports 162) are positioned on the lower surface 160. The strainer supports 162 hold the strainer 104 above the lower surface 160 and inhibit the strainer 104 from rotating within the housing chamber 138 as fluid passes through the pot 102. The housing base 158 further includes a drain nipple passageway 164 in fluid communication with the housing chamber 138 and a drain nipple 166, which facilitate selectively draining the housing chamber 138 via a drain conduit 168.

With continued reference to FIG. 1, the outlet port 110 includes an outlet wall 170 that defines an outlet passageway 172, and the outlet passageway 172 is in fluid communication and receives fluid from the housing chamber 138. The outlet passageway 172 is also illustratively in fluid communication with one or more auxiliary passageways, more specifically an upper outlet nipple passageway 174 of an upper outlet nipple 176 and a lower outlet nipple passageway 178 of a lower outlet nipple 180. The upper outlet nipple 176 and the lower outlet nipple 180 couple to pressure transducers, more specifically, an upper outlet pressure transducer 182 and a lower outlet pressure transducer 184, respectively. The outlet pressure transducers 182, 184, together with the inlet pressure transducers 132, 134, facilitate determining a pressure differential across the strainer 104 and thereby determining if the basket strainer 100 is excessively filled with particulate matter and requires servicing.

The outlet wall 170 also defines an outlet flange 186 that abuts a downstream conduit D. The outlet flange 186 may be provided with various sizes, depending on the size of the downstream conduit D. The outlet flange 186 couples to the downstream conduit D via an outlet mounting ring 188 that is movably mounted over the outlet wall 170 and a plurality of outlet fasteners 190 received by the outlet mounting ring 188. The outlet wall 170 defines at outlet opening 192 within the outlet flange 186, and the outlet opening 192 is in fluid communication with and receives fluid from the outlet passageway 172. The outlet opening 192 is also in fluid communication with the downstream conduit D.

With further reference to FIG. 1, the outlet port 110 has an outer diameter, apart from the outlet flange 186, of about 8 inches. In other embodiments, the outlet port 110 has a different outer diameter. The outlet wall 170 of the outlet port 110 has a thickness according to SDR7. In other embodiments, the outlet port 110 has a different wall thickness, such as SDR11.

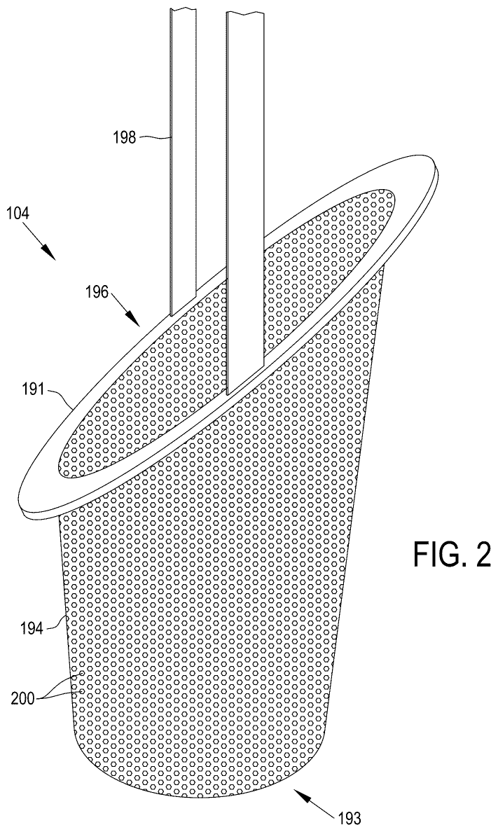

With further reference to FIG. 1 and additional reference to FIG. 2, the strainer 104 generally includes an upper rim 191, a lower base 193, and a strainer wall 194 disposed therebetween. The upper rim 191 defines a strainer opening 196 (FIG. 2) that permits fluid in the housing chamber 138 to enter the strainer 104. The strainer 104 also includes a handle 198 coupled to the rim 191, which facilities selectively removing the strainer 104 from the pot 102. The strainer 104 is constructed of one or more corrosion-resistant materials, such as corrosion-resistant metals, more specifically stainless steel (SS). In other embodiments, the strainer 104 is constructed of one or more different materials.

The strainer 104 includes a plurality of apertures 200 defined in the strainer wall 194, which permit fluid to pass therethrough while the strainer 104 captures particulate matter in the fluid that has a size greater than that of the apertures 200. In some embodiments, each of the apertures 200 has a diameter of about ⅛ inch to about ¼ inch. In some embodiments, and as described in further detail below, each of the apertures 200 has a diameter of about ⅛ inch. In some embodiments, and as described in further detail below, each of the apertures 200 has a diameter of about ¼ inch. In some embodiments, each of the apertures 200 has a diameter of about 11/32 inch, about 5/16 inch, about 9/32 inch, about 7/32 inch, about 3/16 inch, or about 5/32 inch. In certain embodiments, the apertures 200 are relatively small compared to those of previous basket strainers, and the basket strainer 100 thereby captures additional particulate matter compared to previous basket strainers. Nevertheless, the basket strainer 100 may be serviced infrequently due to the relatively large size of the pot 102, as described above.

The rim 191 of the strainer 104 extends diagonally relative to the base 193 such that the strainer wall 194 is absent near the inlet passageway 122, and the fluid thereby passes from the inlet passageway 122 into the housing chamber 138, through the strainer opening 196, and into the strainer 104. Conversely, the strainer wall 194 is present near the outlet passageway 172, and the fluid thereby passes through the apertures 200, into the outlet passageway 172, and out of the basket strainer 100.

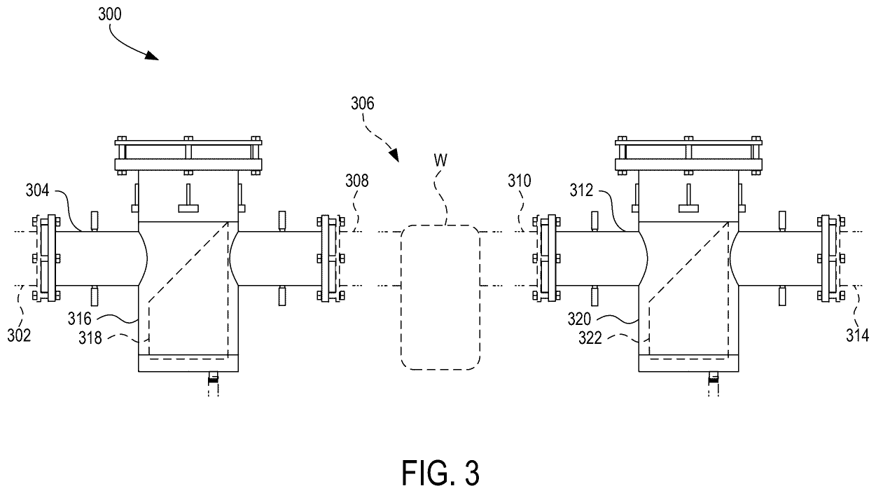

FIG. 3 illustrates an oil recovery system 300, according to an embodiment of the present disclosure. The system 300 generally includes an upstream conduit 302 that provides a first fluid (for example, water, more specifically salt water) to a first basket strainer 304, and the first basket strainer 304 filters and provides the first fluid to intermediate recovery equipment 306, more specifically a first intermediate conduit 308 of the intermediate recovery equipment 306. The first intermediate conduit 308 provides the first fluid to a well W (for example, via one or more additional devices of the intermediate recovery equipment 306, such as pumps and the like—not shown). The well W provides a second fluid (for example, oil, more specifically crude oil) to a second intermediate conduit 310 of the intermediate recovery equipment 306 (for example, again via one or more additional devices of the intermediate recovery equipment 306, such as pumps and the like - not shown). The second intermediate conduit 310 provides the second fluid to a second basket strainer 312, and the second basket strainer 312 filters and provides the second fluid to a downstream conduit 314.

The first basket strainer 304 may be the same or similar to any of the basket strainers described herein, such as the basket strainer 100 described hereinabove. That is, the first basket strainer 304 may include a first pot 316 that carries a first strainer 318, or more generally, the first basket strainer 304 may have any of the components of the basket strainer 100 and may be described as having such components preceded by the word “first.” The apertures of the first basket strainer 304 may have a size that is appropriate for removing particulate matter from water to be delivered to the well W. For example, the apertures of the first basket strainer 304 may have a diameter of about ⅛ inch. As another example, the apertures of the first basket strainer 304 may have a different diameter, such as any of the diameters contemplated for the strainer 104.

The second basket strainer 312 may be the same or similar to any of the basket strainers described herein, such as the basket strainer 100 described hereinabove. That is, the second basket strainer 312 may include a second pot 320 that carries a second strainer 322, or more generally, the second basket strainer 312 may have any of the components of the basket strainer 100 and may be described as having such components preceded by the word “second.” The apertures of the second basket strainer 312 may have a size that is appropriate for removing particulate matter from oil received from the well W. For example, the apertures of the second basket strainer 312 may have a diameter greater than those of the of the first basket strainer 304. As a specific example, the apertures of the second basket strainer 312 may have a diameter of about ¼ inch. As another example, the apertures of the second basket strainer 312 may have a different diameter, such as any of the diameters contemplated for the strainer 104.

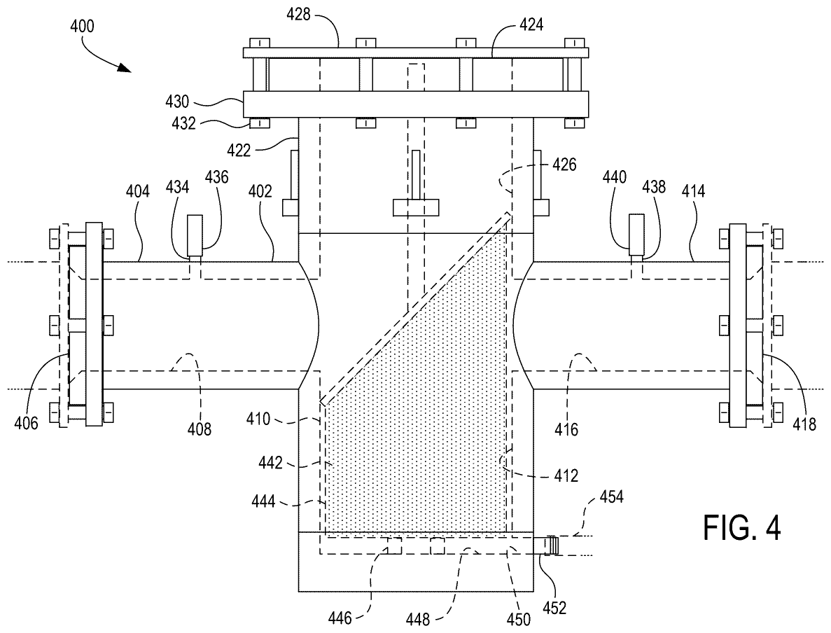

FIG. 4 illustrates a basket strainer 400 for an oil recovery system, according to another embodiment of the present disclosure. The basket strainer 400 is similar to the basket strainer 100 described hereinabove. Generally the basket strainer 400 includes a pot 402 constructed, for example, of high-density polyethylene. The pot 402 includes an inlet port 404 having a beveled inlet opening 406 and an inlet passageway 408 in fluid communication with the inlet opening 406. The pot 402 also includes a strainer 410 housing including a housing chamber 412 in fluid communication with the inlet passageway 408. The pot 402 further includes an outlet port 414 having an outlet passageway 416 in fluid communication with the housing chamber 412 and a beveled outlet opening 418 in fluid communication with the outlet passageway 416. A strainer 410 is positioned in the housing chamber 412, and the strainer 410 removes particulate matter from a fluid flowing from the inlet opening 406 through the inlet passageway 408, the housing chamber 412, the outlet passageway 416, and out of the outlet opening 418.

The pot 402 includes an access port 422 that defines an access opening 424 and an access passageway 426 in fluid communication with the access opening 424 and the housing chamber 412. The strainer 410 is removable from the housing chamber 412 via the access passageway 426 and the access opening 424. An access cover 428 couples to the access port 422 via an access mounting ring 430 that is movably mounted over the access port 422 and a plurality of access fasteners 432, for example, Teflon® coated fasteners, received by the access mounting ring 430.

Illustratively, the inlet port 404 includes an inlet nipple 434, for example a stainless steel nipple, and an inlet pressure transducer 436 is coupled to the inlet nipple 434. Similarly, the outlet port 414 includes an outlet nipple 438, for example a stainless steel nipple, and an outlet pressure transducer 440 is coupled to the outlet nipple 438.

The strainer 410 may be the same as or similar to the strainer 104 described hereinabove. Generally, the strainer 410 includes a strainer wall 442 and a plurality of apertures 444 defined in the strainer wall 442. The strainer wall 442 may be constructed of, for example, stainless steel. Each of the plurality of apertures 444 may have a diameter of about ⅛ inch, ¼ inch, or any of the other diameters described herein. The strainer 410 may have an outer diameter of about 16 inches.

The pot 402 further includes one or more strainer supports 446 positioned on a lower surface 448 of the housing chamber 412. The strainer 410 is positioned on the strainer supports 446. The pot 402 further includes a drain nipple passageway 450 in fluid communication with the housing chamber 412 and a substantially horizontally-extending drain nipple 452, which facilitate selectively draining the housing chamber 412 via a drain conduit 454.

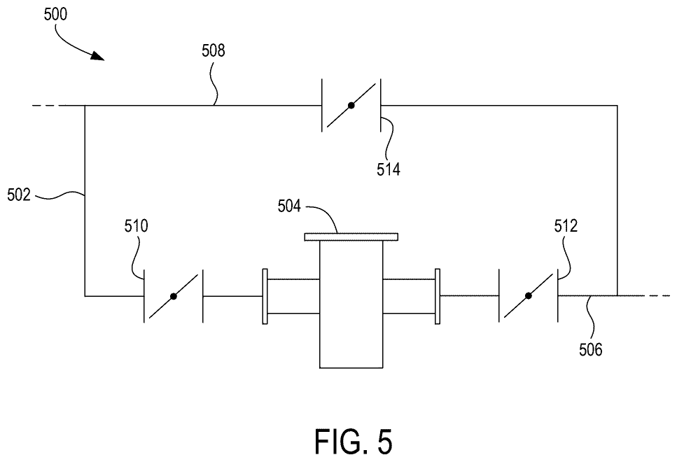

FIG. 5 illustrates an oil recovery system 500, according to an embodiment of the present disclosure. The system 500 generally includes an upstream conduit 502 that provides a fluid (for example, water) to a basket strainer 504, which may be any of the basket strainers described herein. The basket strainer 504 filters and provides the fluid to a downstream conduit 506. The system 500 also includes a bypass conduit 508 in fluid communication with both the upstream conduit 502 and the downstream conduit 506. One or more valves, for example, butterfly valves, are positioned along the conduits 502, 506, and 508 and are configured to direct flow away from the basket strainer 504, which facilitates servicing the basket strainer 504. Illustratively, the the system 500 includes an upstream valve 510 positioned along the upstream conduit 502, a downstream valve 512 positioned along the downstream conduit 506, and a bypass valve 514 positioned along the bypass conduit 508.

In some embodiments and as illustrated, the system 300 lacks any bleeder rings (for example, facilitating pressure measurements or draining fluids) coupled to the first basket strainer 304 or the second basket strainer 312.

Various other modifications and additions can be made to the exemplary embodiments discussed without departing from the scope of the present invention. For example, while the embodiments described above refer to particular features, the scope of this invention also includes embodiments having different combinations of features and embodiments that do not include all of the above-described features.

What is claimed is:

1. A basket strainer for an oil recovery system, the basket strainer comprising:
a pot constructed of high-density polyethylene, the pot including:
an inlet port including an inlet opening and an inlet passageway in fluid communication with the inlet opening;
a strainer housing including a housing chamber in fluid communication with the inlet passageway;
an outlet port including an outlet passageway in fluid communication with the housing chamber and an outlet opening in fluid communication with the outlet passageway; and
a strainer positioned in the housing chamber and configured to remove particulate matter from a fluid flowing from the inlet opening through the inlet passageway, the housing chamber, the outlet passageway, and out of the outlet opening.

2. The basket strainer of claim 1, wherein the inlet port further includes an inlet nipple, and the basket strainer further comprises an inlet pressure transducer coupled to the inlet nipple.

3. The basket strainer of claim 1, wherein the outlet port further includes an outlet nipple, and the basket strainer further comprises an outlet pressure transducer coupled to the outlet nipple.

4. The basket strainer of claim 1, wherein the strainer includes a strainer wall and a plurality of apertures defined in the strainer wall, each of the plurality of apertures having a diameter of about ⅛ inch.

5. The basket strainer of claim 1, wherein the strainer includes a strainer wall and a plurality of apertures defined in the strainer wall, each of the plurality of apertures having a diameter of about ¼ inch.

6. The basket strainer of claim 1, wherein the strainer includes a strainer wall and a plurality of apertures defined in the strainer wall, the strainer wall being constructed of stainless steel.

7. The basket strainer of claim 1, wherein the strainer housing has an outer diameter of about 16 inches.

8. The basket strainer of claim 1, wherein the inlet port has an outer diameter of about 8 inches.

9. The basket strainer of claim 1, wherein the strainer housing has a wall thickness according to SDR7.

10. The basket strainer of claim 1, further comprising a strainer support positioned in the housing chamber, the strainer support supporting the strainer.

11. The basket strainer of claim 10, wherein the housing chamber is partially defined by a lower surface, and the strainer support is positioned on the lower surface.

12. The basket strainer of claim 1, further comprising an access port defining an access opening and an access passageway in fluid communication with the access opening and the housing chamber, the strainer being removable from the housing chamber via the access passageway and the access opening.

13. The basket strainer of claim 12, further comprising:
an access cover; and
an access mounting ring movably positioned on the access port, the access mounting ring selectively coupling the access cover to the access port.

14. The basket strainer of claim 13, further comprising a mounting ring stop coupled to the access port, the mounting ring stop limiting movement of the access mounting ring relative to the access port.

15. An oil recovery system comprising:
a first basket strainer including:
a first pot including:
a first inlet port including a first inlet opening and a first inlet passageway in fluid communication with the first inlet opening;
a first strainer housing including a first housing chamber in fluid communication with the first inlet passageway;
a first outlet port including a first outlet passageway in fluid communication with the first housing chamber and a first outlet opening in fluid communication with the first outlet passageway;
a first strainer positioned in the first housing chamber, the first strainer including a first strainer wall and a plurality of first apertures defined in the first strainer wall, each of the plurality of first apertures having a first diameter, and the first strainer configured to remove particulate matter from water flowing from the first inlet opening through the first inlet passageway, the first housing chamber, the first outlet passageway, and out of the first outlet opening;
intermediate recovery equipment in downstream fluid communication with the first basket strainer and receiving water from the first basket strainer;
a second basket strainer in downstream fluid communication with the intermediate recovery equipment and receiving crude oil from the intermediate recovery equipment, the second basket strainer including:
a second pot including:
a second inlet port including a second inlet opening and a second inlet passageway in fluid communication with the second inlet opening;
a second strainer housing including a second housing chamber in fluid communication with the second inlet passageway;
a second outlet port including a second outlet passageway in fluid communication with the second housing chamber and a second outlet opening in fluid communication with the second outlet passageway; and
a second strainer positioned in the second housing chamber, the second strainer including a second strainer wall and a plurality of second apertures defined in the second strainer wall, each of the plurality of second apertures having a second diameter, the second diameter being greater than the first diameter, and the second strainer configured to remove particulate matter from crude oil flowing from the second inlet opening through the second inlet passageway, the second housing chamber, the second outlet passageway, and out of the second outlet opening.

16. The oil recovery system of claim 15, wherein the first diameter is about ⅛ inch.

17. The oil recovery system of claim 16, wherein the second diameter is about ¼ inch.

18. The oil recovery system of claim 15, wherein the second diameter is about ¼ inch.

19. The oil recovery system of claim 15, wherein the first basket strainer is constructed of high-density polyethylene.

20. The oil recovery system of claim 15, wherein the oil recovery system lacks any bleeder rings coupled to the first basket strainer and the second basket strainer.
